(19) United States
(12) Patent Application Publication
(10) Pub. No.: US 2005/0184431 A1
(43) Pub. Date: Aug. 25, 2005

(54) Method of manufacturing container top parts forming container lids

(76) Inventor: Henning Steg, Tyreso (SE)

Correspondence Address: KLAUS J. BACH, 4407 TWIN OAKS DRIVE, MURRYSVILLE, PA, 15668, US

(21) Appl. No.: 10/802,684

(22) Filed: Mar. 17, 2004

(30) Foreign Application Priority Data
Feb. 25, 2004 (EP) 04 004 275.6

(51) Int. Cl. B29C 45/14

(52) U.S. Cl. 264/259; 264/328.1

(57) ABSTRACT

In a method for the manufacture of container top parts serving as covers of containers for solid, paste-like as well as flowable or particulate products, particularly for food products, wherein a foil is disposed on and joined to the container top part and wherein at least the container top part consists of a plastic material, the jointure between the container top part and the foil is established by plastic material which forms the container top part while it is plasticized during injection into an injection mold, into which the foil is placed and heated to a predetermined temperature before the plastic material forming the top part is injected into the injection mold and the and the top part and the foil joint therewith are then permitted to jointly cool down.

### BACKGROUND OF THE INVENTION

The invention relates to a method of manufacturing container top parts forming container lids of containers for solid, paste-like, flowable, or particulate products, particularly for food products wherein a foil is disposed on the container top part and wherein at least the container top part consists of a plastic material.

In European patent application, 03 010 210.1, a container is described for containing solid, paste-like, as well as flowable and particulate products, particularly food products. This container comprises a lower container part for containing the product and a container top part serving as a container lid. On the container top part, a foil is disposed which is provided with printed or pictorial information concerning the container content and possibly instructions concerning the use of the container content. Such foils which are also called labels are applied to containers particularly to plastic containers of the type described above. They have been known in the state of the art for a long time.

Generally, such foils which consist often of polypropylene are connected, after having been imprinted with text or pictures, to the respective container parts on which they are disposed or to which they are connected, by means of an “In Mold Labeling” technique or short, an IML connection technique. This known connecting technique utilizes the fact that the support is in a plasticized state and the foil which is introduced into the mold at a suitable location is brought into contact with the injected plastic material wherein the support or, respectively, a container part on which the foil is to be disposed is in a plasticized state. When the material forming the container cools down and solidifies, a firm connection is formed between the foil and the container part.

If, for example, container covers are provided with a foil, the container covers, which, based on their thickness, generally are relatively large, are curved in several directions even if the container covers include reinforcement structures when such a container cover is injection molded from plastic material and a foil is disposed thereon by the IML technique.

This is essential because normally the injection mold, into which the foil is placed, is at a substantially lower temperature than the plastic material melt forming the container cover. In this process, the foil placed into the injection mold and pressed by the melt against the solid wall of the mold acts additionally as an insulator.

When the molding procedure is completed, the foil is joined at the surface area thereof with the injection-molded material forming the container cover and the cover cools down. In addition, the material, of which the foil consists, is often different from the material which forms the cover. Because the cover cools down at a rate different from that of the foil, tensions develop between cover and the foil so that when the two elements are joined and cooled, the cover always becomes curved in several degrees of freedom, that is, the cover is curved concavely with respect to the foil.

Procedurally, it is very problematic to use such warped combined covers and foils in an automated manufacturing process, that is, to mount them onto a container which is filled with the desired product and to close the container hermetically with such a warped cover in an airtight manner so that it is protected from outer influences.

Particularly with the use of such covers of joined foils and cover parts for containers containing perishable products such as foods, a hermetic closure between the cover forming the top part of the container and the lower container part, that is the actual container into which the product is filled, is absolutely necessary in order to ensure a germ-free preservation of the product in the closed container.

The covers, which are warped occasionally in several directions can, after their manufacture, that is after having been joined with a foil, be mounted onto a container only with the use of expensive procedural measures for handling such a compound cover. As a result, expensive procedures must be established in order to position such covers accurately on the container and maintain it in their proper position until the closing procedure is completed.

In a fully automated manufacturing or closing apparatus, the covers, after being positioned on the container for closing the container, must be held in this position in order to prevent defective connections and to keep waste within minimal limits. With presently available methods, this is not guaranteed in a way as it is desirable from manufacturing and hygienic points of view.

It is therefore the object of the present invention to provide a method for the manufacture of container covers of the type referred to above, which consist of a base cover, which forms an upper container part and a foil applied to the cover and which are still planar after the jointure, so that the storing of cover and foil element prepared in this way can be achieved with simple means and also a closure of containers with such covers provides for a hermetically sealed mounting of the cover or, respectively, the upper container part on the lower container part. Such a procedure should be easy to realize and easily controllable so that the method of manufacturing the container top part, or cover as well as the closing of the container with such a cover is easy to achieve.

### SUMMARY OFBTHE INVENTION

In a method for the manufacture of container top parts serving as covers of containers for solid, paste-like as well as flowable or particulate products, particularly for food products, wherein a foil is disposed on and joined to the container top part and wherein at least the container top part consists of a plastic material, the jointure between the container top part and the foil is established by plastic material which forms the container top part while it is plasticized during injection into an injection mold, into which the foil is placed and heated to a predetermined temperature before the plastic material forming the top part is injected into the injection mold and the and the top part and the foil joint therewith are then permitted to jointly cool down.

The foil is heated preferably in such a way that, the temperature-dependent expansion coefficient of the material of which the foil consists and the temperature-dependent expansion coefficient of the injection material of which the container top part or respectively the cover consists, are adapted to one another and the temperature of the foil is adapted to the temperature of the plasticized injection molding material of which the container top part or, respectively, cover in the injection mold consist and into which the foil is placed.

In this way also, the flow behavior of the material which is injected into the injection mold and which forms the container top part or cover is improved, since the foil is no longer a “cold” insulator, but the foil is maintained at a higher temperature range so that the temperature difference between the foil and the plastic material of which the cover consists is not as large as it is in the state of the art methods.

This measure has additionally the advantage that the connection, that is, the adhesion between the cover and the foils is improved. Upon cooling of the joined cover and foil after manufacture, the cover and the foil connected thereto shrink synchronously with the result that the cover and the foil, after cooling down to ambient temperature, form a planar structure, that is, a planar compound arrangement.

In practical tests the solution according to the invention has been found to fulfill all expectations.

In another advantageous embodiment of the method, the foil is heated already during its transfer from the storage location to its position in the injection mold so that, in the injection mold, its temperature only needs to be adjusted by a corresponding addition or removal of heat for an appropriate connection between the foil and the injection-molded cover in the injection mold. By preheating the foil before it is placed into the injection mold, it will assume its temperature-dependent form by a corresponding pre-expansion.

In the method known from the state of the art, as initially pointed out, the injection mold has generally been cooled. In accordance with the invention, this practice has intentionally been abandoned, that is, the temperature adjustment is obtained in accordance with the invention always by heating in order to provide also in the injection mold as small a temperature difference as possible between the injection molding material for the cover and the foil that is to make the temperature difference approach the value zero.

To this end, the foil may also still be heated during the formation of the jointure with the container top part, or, respectively, the cover element in the injection mold. For example, heat may be supplied separately to the part of the injection mold against which the foil is pressed during the injection of the plastic material forming the cover element. This can be achieved for example by electrical heating means, but also by liquid or gaseous heat carriers.

Preferably the temperature of the injection mold is maintained during injection molding of the container top part and its connection with the foil in the area of 65° C. if the material from which the container top part is formed is for example polypropylene. It is however pointed out that the temperature of 65° C. is only exemplary which is for the material propylene. This is substantially higher than the temperature used in the state of the art which is in the area of 10° C. If another material is selected for forming the container top part and/or also for the foil, the temperature range may change correspondingly. It is expedient but not necessary to choose the same material for the container cover and for the foil, for example, polypropylene or another suitable material which can be injection molded and imprinted or otherwise optically marked.

It is also advantageous if the temperature of a device by which the foil is transferred to the injection mold is maintained at the same temperature which is provided for the foil in the injection mold, for example at a temperature of 65° C. to 80° C. In this way, the foil has reached its desired temperature-dependent expansion when it is placed into injection mold.

Also during the transfer of the foil by the handling device, the handling device may be heated by heat transfer media such as hot air or by electrical heating means.

The temperature of the plasticized plastic material, which forms the container top part, is maintained during injection into the injection mold preferably in the range of 230 to 240° C. However, this temperature may be changed depending on the material forming the container top part or respectively cover and the material forming the foil. The temperature of 230 to 230° C. is essentially the temperature range desirable for the material polypropylene.

In order to provide for a uniform temperature distribution in the foil for the manufacture of the cover, it is finally advantageous to heat already the storage area for the foils so that during the transfer of the foil for example by the transfer device from the storage location to its position in the injection mold, only so much heat has to be supplied to the foil as is needed to compensate for heat losses during the transfer from the storage area to the position in the injection mold. Then also the heating means in the transfer or handling device may be relatively simple which is equally true for the respective temperature control means.

The method may expediently be so configured that the foil is applied to the container top part or connected thereto by the method of the invention in such a way that, the foil is at least partially removed for opening the container bottom part which is closed by the container top part.

The invention will be described below in greater detail on the basis of the attached schematic drawings showing a particular embodiment of the invention.

### BRIEF DESCRIPTION OF THE DRAWINGS

FIG. 1 IS a side view of a container top part which can be manufactured by the method,

FIG. 2 SHOWS the container top part of FIG. 1 from the bottom,

FIG. 3 IS a perspective representation of a handling device with a foil of FIGS. 1 and 2 disposed thereon,

FIG. 4 IS a representation according to FIG. 3 wherein however the foil is shown only in dash-dotted lines to more clearly show the design of the handling device,

FIG. 5 shows a mold top part for the manufacture of the container top part or respectively container cover, consisting of four identical injection mold areas,

FIG. 6a shows the injection mold top part according to FIG. 5 in a sectional side view,

FIG. 6b shows an injection mold bottom part in a cross-section which cooperates with the injection mold top part, the injection mold top part according to FIG. 6a being shown in spaced relationship from the injection mold bottom part,

FIG. 7a shows the injection mold top part according to FIG. 6a, and

FIG. 7b shows the injection mold bottom part according to FIG. 6b wherein the injection mold top part and the injection mold bottom part are joined for forming the container top part or respectively, the composite cover part and foil in the injection mold in which the foil is positioned.

### DESCRIPTION OF A PREFERRED EMBODMENT

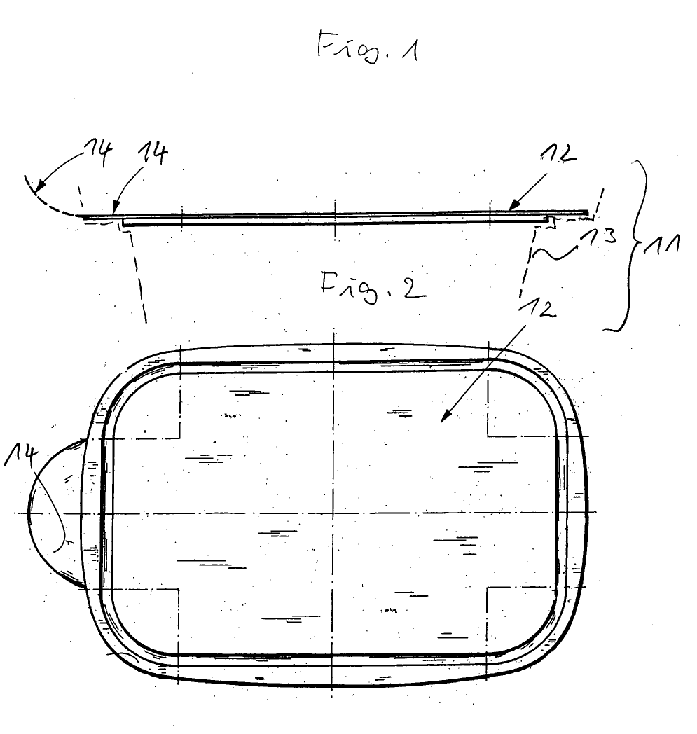

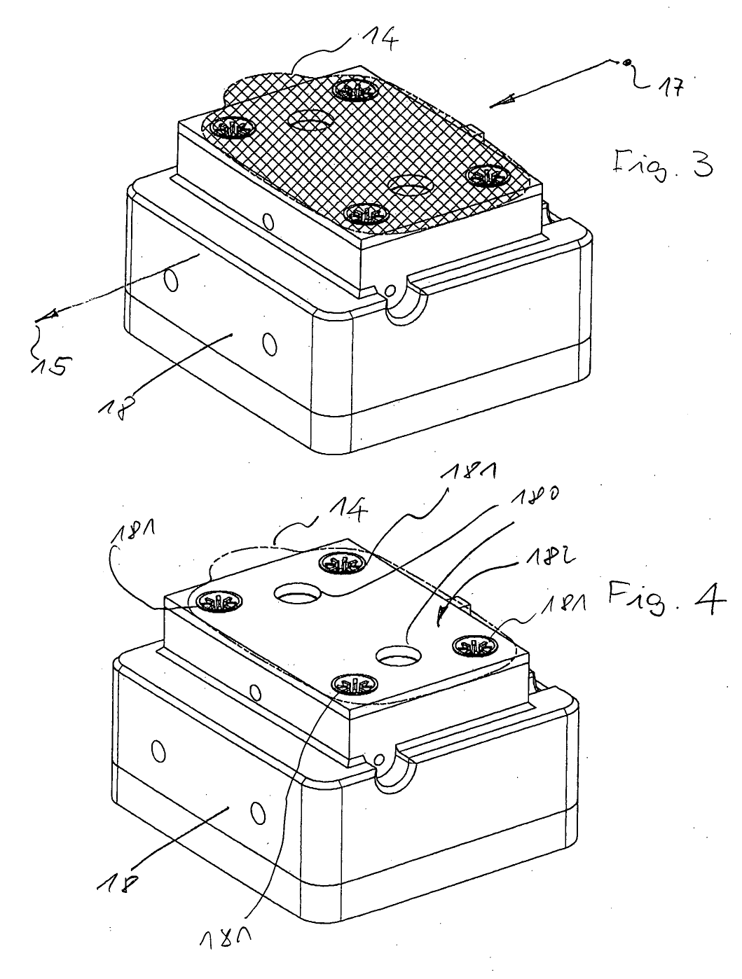

First, reference is shortly made to the container top part or container cover 12 manufactured by the method according to the invention and shown schematically in FIGS. 1 and 2. The container top part 12 consists of an essentially flat body of an injection-moldable material to which a foil 14 is applied. On the foil 14, optically noticeable instructions may be provided such as images and/or print providing information concerning the content of the container 11, which is closed by a cover 12 according to the invention and which is shown in FIG. 1 only schematically by dashed lines. Generally, the container top part 12 and the foil 14 consist of the same plastic material, for example OF polypropylene. The plastic material forming the container top part 12 and the container bottom part 13 however may also be different.

Concerning the design of the container 11, that is, the container top part 12 and the container bottom part 13, reference is made to European patent application No. 03 010 270.1.

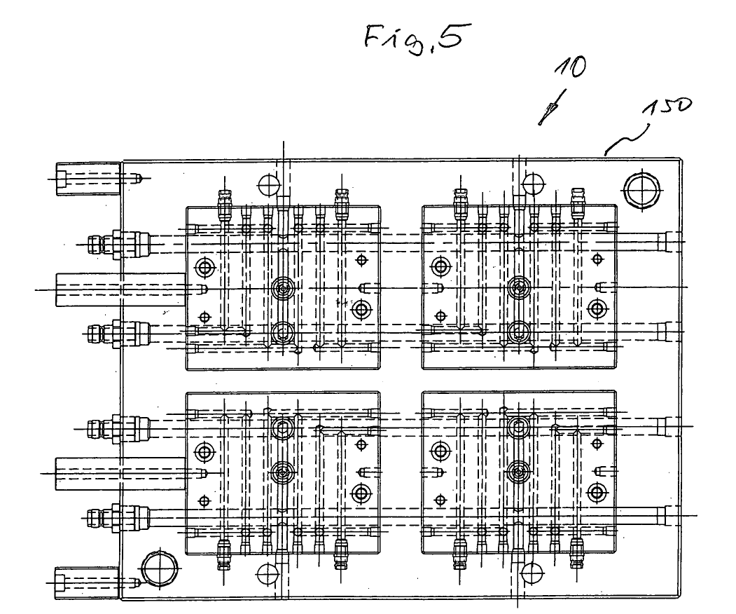

The method according to the invention for manufacturing of container covers serving as top part 12 of the containers 11 is performed for example by means of a device as it is shown in FIGS. 5 to 7 using a handling device as it is shown in FIGS. 3 and 4.

The arrangement 10 comprises essentially an injection mold 15, which consists of an injection mold top part 150 and an injection mold bottom part 151, as they are shown in FIGS. 5 to 7. Injection molds of this type are known in the state of the art as far as their basic design and function are concerned, so that for an understanding of the invention, no particular details need to be described in herein.

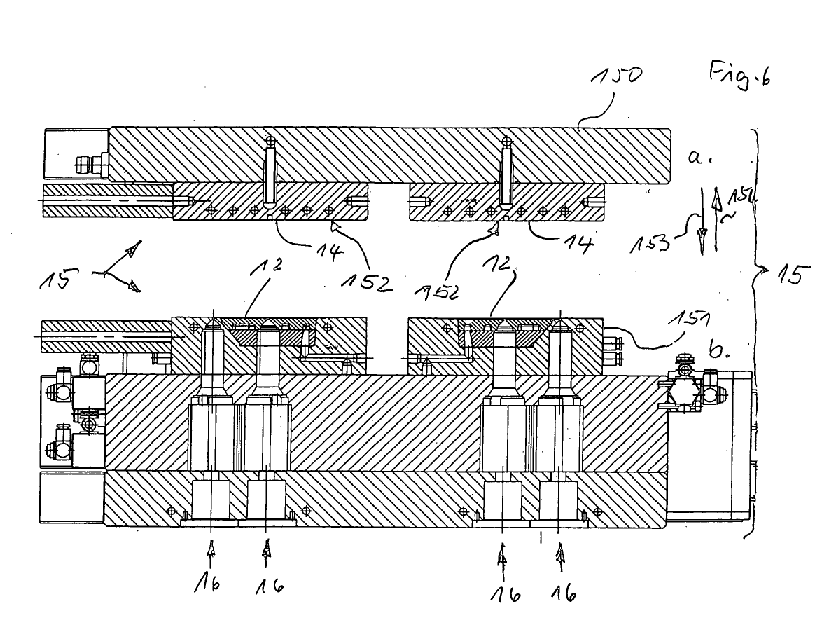

From a storage location 17, see FIG. 3, where the foil 12 is provided in a suitably contoured form—the foil is transferred by a handling device 18 into the injection mold 15, or respectively, the injection mold top part 150 and is positioned therein—see FIG. 6a. At the storage location 7 as well as during transfer of the foil 14 to the position location 152 in the injection mold bottom part 151, the foil 14 is suitably heated for example to a temperature in the range of 65° C. to 80° C. if the material of which the foil 14 consists is propylene.

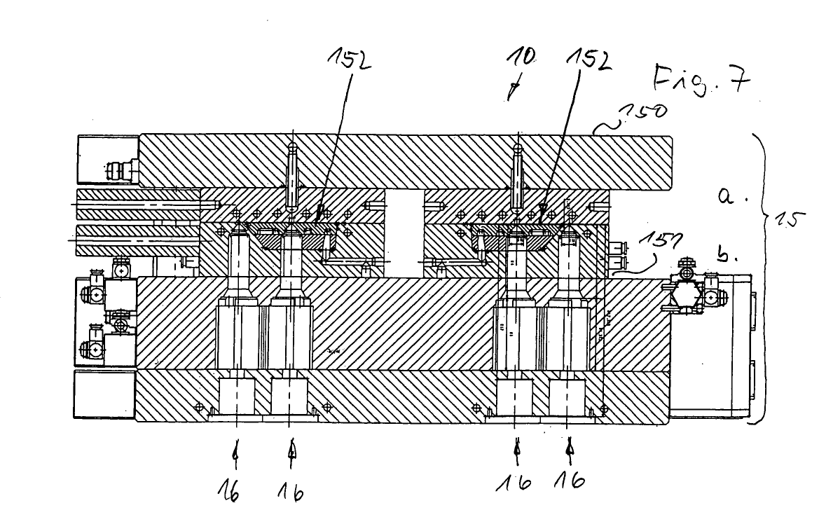

When the foil 14 is positioned in the positioning location 152 on the injection mold top part 150, the injection mold top part 150 is moved in the direction of the arrow 153 toward the injection mold bottom part 151—see FIG. 6—until the injection mold top part 150 is disposed on top of the injection mold bottom part 151—see FIG. 7. But it is basically also possible that the foil is positioned directly on the injection mold bottom part 151, that is, directly over the area of the mold recess into which the material forming the container cover is injected.

Subsequently, the plastic material 16 is injected in a known way through openings in the injection mold bottom part 151 into a recess which is in the shape of the container top part 12 and which is formed in the injection mold bottom part 151 at temperatures of between 230° to 240° C. (with propylene as the material forming the container cover). The foil 14 is joined in the process to the material 16 forming the container top part 12. This joining method is designated “In Mold Labeling”, in short IML-technique. After completion of the injection molding procedure, the injection mold top part 150 can be opened in the direction of the arrow 154 and the container top part 12, which then forms a compound structure with the foil 14 can be removed and can be supplied to a storage area or, respectively to a further processing station if this should be necessary.

The foil 14 can be heated in the injection mold 15 in the injection mold top part 150 or in the injection mold bottom part 151 by means of liquid and/or gaseous suitably heated media, but it may also be heated electrically. Since the various techniques for the heating of injection molds are well known in the art, they do not need to be described in detail.

The handling device 18, see FIGS. 3 and 4, has holes 181 by way of which suitably heated air can be introduced. The foil 14 is transferred by means of the handling device 18 from the storage location 17 to the positioning location 152 in the injection mold 15. During this transfer, the foil 14 is heated already to a suitable temperature as it is desired or necessary for the positioning location 152 in the injection mold 15.

In FIGS. 3 and 4, the handling device 18 is shown provided only with two holes, but more holes may be provided over the whole surface thereof depending on the size of the foil 14. Instead of warm air, the foil may during its transport to the positioning location 152 also be heated by liquid media or electric heating means. The holes 181, which are for example arranged in the corner areas of the handling device 18, generate with respect to the ambient a slightly reduced pressure when the foil 14 is disposed on the respective transport device 182 of the handling device 18. With a slight vacuum, the foil 14 is retained on the transport surface 182 during the transfer from the storage location 17 to the positioning location 152 in the injection mold 15. At the positioning location 152, the vacuum is then deactivated and changed to a slight pressure so that the foil 14 can be properly positioned in the injection mold 15 or, respectively on the injection mold top part 150 or possibly in the injection mold lower part 151.

### LISTING OF REFERENCE NUMERALS

10 arrangement
11 container
12 container top part/container cover
13 container bottom part
14 foil
15 injection mold
150 injection mold top part
151 injection mold bottom part
152 position location
153 arrow
154 arrow
16 plastic material
17 storage location/storage
18 handling device
180 hole
181 hole
182 transport surface

1. A method of manufacturing a container top part (12) forming a cover of a container (11) for solid, paste-like liquid and particulate products, particularly food products, wherein a foil (14) is provided on the container top part (12) and wherein at least the container top part (12) consists of a plastic material, said method comprising the steps of providing an injection mold (15) having a cavity corresponding to said container top part (12), placing said foil (14) into said injection mold (15) and heating said foil (14) to a predetermined temperature before it is contacted by a plastic material injected into said injection mold (15), injecting said plastic material into said injection mold (15) in contact with said heated foil (14) to establish a connection between the container top part (12) and the heated foil (14) in the injection mold (15) and permitting said container top part (12) and the foil (14) connected thereto to jointly cool down so as to form said container top part with said foil joined therewith.

2. A method according to claim 1, wherein, said foil (14) is transferred to said injection mold from a storage location (17) or its location of manufacture (152) and is heated during the transfer from to the injection mold (15).

3. A method according to claim 1, wherein the foil (14) is heated upon placement into the injection mold (15).

4. A method according to claim 1, wherein the foil (14) is so applied to the container top part (12) that, for opening the container bottom part (13) which is closed by the container top part (12), the foil (14) is removable from the container top part (12).

5. A method according claims 1, wherein the container top part (12) consists of polypropylene.

6. A method according to claims 1, wherein the temperature of the injection mold (15) is maintained during the injection procedure of the container top part (12) and its jointure with the foil (14) in the area of 65° C.

7. A method according to claims 2, wherein the foil (14) is transferred into the injection mold (15) by a handling device (18) and the temperature of a handling device (18) is maintained at a temperature in the area of 80° C. for heating the foil (14) during its transfer.

8. A method according to claim 8, wherein, during the transfer by the handling device (18), the foil (14) is exposed to hot air.

9. A method according to claim 1, wherein the temperature of the plastic material (16) which forms the container top part is maintained in the range of 230 to 240° C., at which the material is plasticized.

10. A method according to claim 1, wherein said foils (14) are stored at a storage location (17) where they are held available and said storage location is temperature-controlled.
